(19) United States
(12) Patent Application Publication
(10) Pub. No.: US 2023/0320291 A1
(43) Pub. Date: Oct. 12, 2023

(54) SYSTEM AND METHOD FOR FLOW REGULATED DRIPPING

(71) Applicant: N-Drip Ltd., Kfar Saba (IL)

(72) Inventors: Zvi MILLER, Kiryat-Tivon (IL); Uri SHANI, Tel-Aviv (IL); Sharon DABACH, Tel-Aviv (IL)

(73) Assignee: N-Drip Ltd., Kfar Saba (IL)

(21) Appl. No.: 18/025,196

(22) PCT Filed: Sep. 13, 2021
(86) PCT No.: PCT/IL2021/051114

§ 371 Date: Mar. 8, 2023

Related U.S. Application Data
(60) Provisional application No. 63/077,746, filed on Sep. 14, 2020.

(51) Int. Cl. A01G 25/02

(52) U.S. Cl. CPC A01G 25/023

(57) ABSTRACT

An irrigation dripper, comprises an external elongated hollow structure having one or more rigid wall and one or more flexible walls, an internal elongated structure introduced into the external structure to form a pathway for flow between the internal structure and the walls, an inlet for providing water to the pathway, and an outlet on the external structure for allowing water to drip out of the pathway.

### RELATED APPLICATION

This application claims the benefit of priority of U.S. Provisional Patent Application No. 63/077,746 filed on Sep. 14, 2020, the contents of which are incorporated herein by reference in their entirety.

### FIELD AND BACKGROUND OF THE INVENTION

The present invention, in some embodiments thereof, relates to irrigation and, more particularly, but not exclusively, to method and system for flow regulated dripping.

Drip irrigation is a watering method that utilizes pressurized water sources and drips water along a distribution pipe in a controlled manner. Drip irrigation systems are considered to be more efficient than surface irrigation systems that typically distribute water in the fields by runoff. Surface irrigation systems require smaller investment and lower energy costs, and these systems typically employ high discharge at the inlet in order to irrigate efficiently and uniformly across a field so that water will reach the end of the field.

In drip irrigation system, drippers are inserted into or mounted onto a water supply line typically at regular intervals. Examples of drippers for drip irrigation system are described in International publication Nos. WO2017/191640 and WO2019/092717, the contents of which are hereby incorporated by reference. These publications describe a dripper with a pathway that is not one-dimensional and that allows bypass routes around obstacles that may be inside the dripper.

It is recognized that due to frictional forces that develop between the water and the supply line, the pressure in the line decreases downstream the water line and after a certain point due to field slopes the pressure in the line increases downstream. As a result, the drip rate from the drippers varies along the line. To reduce the drip rate variations, flow regulated drippers have been developed. These drippers produce a somewhat uniform flow over a range of pressures. For example, U.S. Pat. No. 10,219,452 discloses a dripper with an inflow part that has hydrophobicity and that prevents low pressure water from entering.

Additional background art includes U.S. Pat. Nos. 9,307,705, 8,317,111, 10,440,903, and 8,511,586, U.S. Published Application No. 2018/0110191, and International publication No. WO 2017/103926.

### SUMMARY OF THE INVENTION

According to an aspect of some embodiments of the present invention there is provided an irrigation dripper. The dripper comprises an external elongated hollow structure having one or more rigid wall and one or more flexible wall, an internal elongated structure introduced into the external structure to form a pathway for flow between the internal structure and the walls, an inlet for providing water to the pathway, and an outlet on the external structure for allowing water to drip out of the pathway.

According to some embodiments of the invention the flexible wall is generally planar in the absence of pressure difference between an inner side and an outer side thereof.

According to some embodiments of the invention the flexible wall is curved in the absence of pressure difference between an inner side and an outer side thereof.

According to some embodiments of the invention a volume defined by the rigid wall has a shape of a cylindrical segment.

According to some embodiments of the invention a volume defined by the rigid wall has a shape of a prism.

According to some embodiments of the invention an outer surface of the rigid wall has two generally planar structures intersecting with the flexible wall.

According to some embodiments of the invention the generally planar structures are parallel to each other.

According to some embodiments of the invention an outer surface of the rigid wall is tapered towards the flexible wall.

According to some embodiments of the invention an outer surface of the rigid wall has two generally planar structures, at an angle to each other, intersecting with the flexible wall.

According to some embodiments of the invention the flexible wall is a membrane attached to the rigid wall.

According to some embodiments of the invention the flexible wall is made of the same material as the rigid wall except at a smaller thickness.

According to some embodiments of the invention the flexible wall is characterized by a Young modulus of from about 5 MPa to about 150 Mpa.

According to some embodiments of the invention a size and a material of the flexible wall are both selected such that a pressure difference of ΔP between an inner side and an outer side thereof, generates an inward displacement of the flexible wall by Ar. Typical values for ΔP are at most 400 cmH₂O or at most 200 cmH₂O or at most 100 cmH₂O or at most 50 cmH₂O or at most 25 cmH₂O or at most 10 cmH₂O or at most 5 cmH₂O or at most 2.5 cmH₂O, and typical values of Δr are at least 10 μm or at least 20 μm or at least 40 μm or at least 80 μm or at least 100 μm, and at most 200 μm.

According to some embodiments of the invention the flexible wall is elastic under the pressure difference ΔP.

According to some embodiments of the invention the internal elongated structure is non-hollow.

According to some embodiments of the invention the external elongated hollow structure is formed with through holes at the rigid wall, the holes being shaped to perturb the flow in response to a pressure drop across the holes.

According to an aspect of some embodiments of the present invention there is provided an irrigation dripper. The irrigation dripper comprises an external elongated hollow structure formed with through holes at a wall thereof, and an internal elongated structure introduced into the external structure to form a pathway for flow between the structures. The holes are optionally and preferably shaped to perturb the flow in response to a pressure drop across the holes. The irrigation dripper also comprises an inlet for providing water to the pathway, and an outlet on the external structure for allowing water to drip out of the pathway.

According to some embodiments of the invention a volume defined by the external structure has a cylindrical shape. According to some embodiments of the invention a volume defined by the external structure has a shape of a prism. Other shapes for the volume defined by the external structure are also contemplated.

According to some embodiments of the invention the internal elongated structure has a cylindrical shape. According to some embodiments of the invention the internal elongated structure has a shape of a prism. Other shapes for the internal elongated structure are also contemplated.

According to some embodiments of the invention a cross section of an outer surface of the external structure, perpendicular to a longitudinal axis, is generally rectangular.

According to some embodiments of the invention an outer surface of the external structure is tapered.

According to some embodiments of the invention the internal elongated structure is non-hollow.

According to some embodiments of the invention the inlet is peripheral with respect to the internal elongated structure.

According to an aspect of some embodiments of the present invention there is provided an irrigation dripping pipe. The irrigation dripping pipe comprises an irrigation pipe provided with a plurality of drippers, each dripper having an inlet for receiving water flowing in the irrigation pipe and an outlet for allowing water flowing in the dripper to drip out of the dripper.

According to some embodiments of the invention at least one of the drippers along the irrigation dripping pipe is the irrigation dripper as delineated above and optionally and preferably as further detailed below.

According to some embodiments of the invention the irrigation pipe has a first end connectable to a water source or a water distribution line, and second end distal to the first end, wherein for at least one of the drippers, the inlet is facing the second end such that an inflow of water into the at least one dripper is opposite to a flow of water in the irrigation pipe. According to an aspect of some embodiments of the present invention there is provided a method of irrigation, the method comprising deploying the irrigation dripping in a field, and supplying water to the irrigation dripping pipe.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A, 1B, 1C, 1D, 1E and 1F are schematic illustrations of an irrigation dripper, according to some embodiments of the present invention;

FIGS. 2A and 2B are schematic illustrations of an irrigation dripping pipe, which comprises an irrigation pipe provided with one or more drippers, deployed in a field, according to some embodiments of the present invention;

FIGS. 3A and 3B are cross-sectional schematic illustrations of a dripper within a pipe, in a plane perpendicular to the longitudinal axis of the pipe, according to some embodiments of the present invention;

FIGS. 4A and 4B are schematic illustrations of a dripper in embodiments of the invention in which a flexible wall is made of the same material as a rigid wall, except at a smaller thickness; and

FIG. 5 is a schematic illustration of a dripper in embodiments of the invention in which flow regulation is facilitated, at least in part, by inducing flow perturbation in a pathway within the dripper.

### DESCRIPTION OF SPECIFIC EMBODIMENTS OF THE INVENTION

The present invention, in some embodiments thereof, relates to irrigation and, more particularly, but not exclusively, to method and system for flow regulated dripping.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In a search for an irrigation dripper that is capable of providing a generally constant flow rate along the dripping line, the Inventors found that conventional flow regulated drippers are far from being optimal, since such drippers are susceptible to clogging issues, and also require relatively high working pressure range. The Inventors therefore devised a flow regulated dripper that is optionally less susceptible to clogging, that can optionally provide a predetermined and generally fixed flow rate at its outlet, and that optionally responsive to low pressure variations. The Inventors also devised an irrigation dripping pipe that can operate more efficiently, both when the drippers along the pipe are flow-regulated, and when they are not flow-regulated.

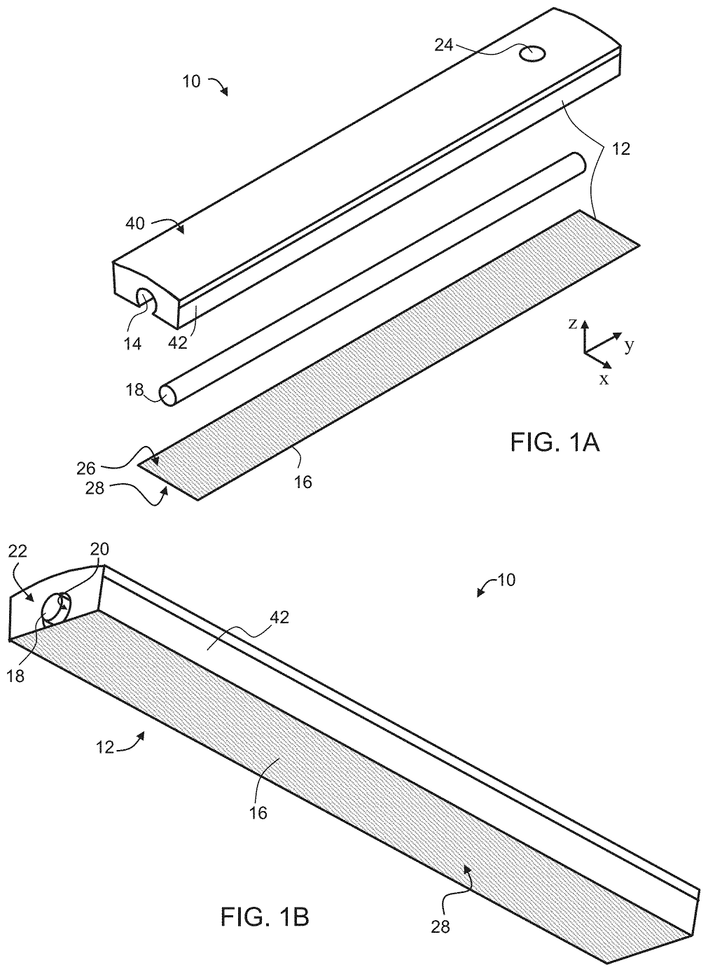

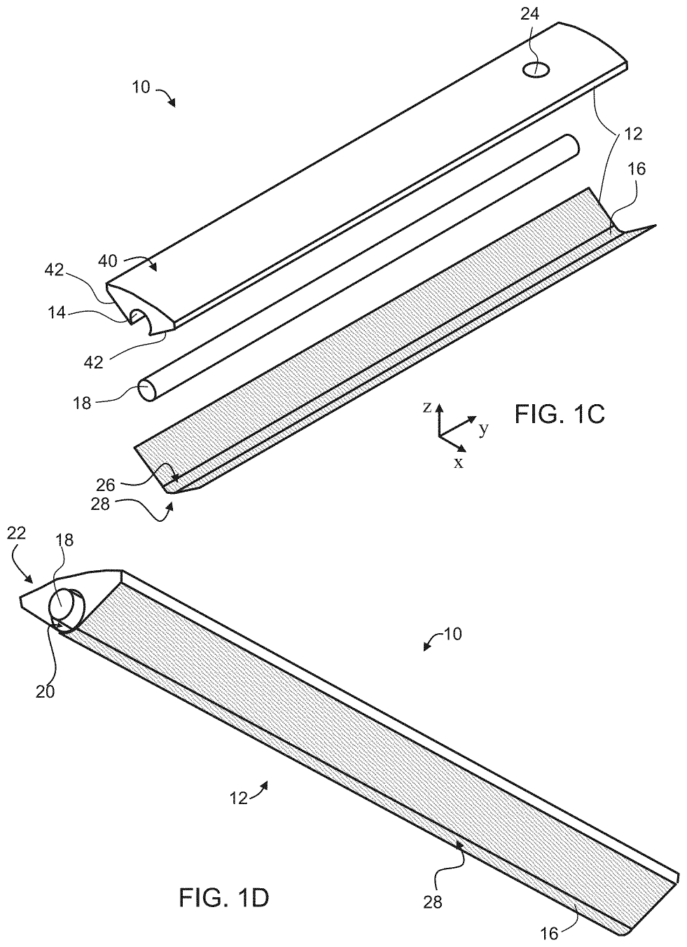

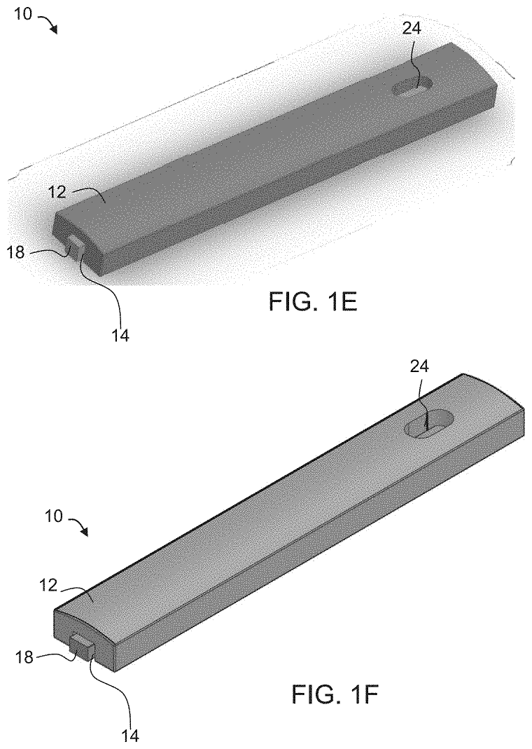

Referring now to the drawings, FIGS. 1A-D are schematic illustrations showing perspective exploded views (FIGS. 1A and 1C), and perspective assembled views (FIGS. 1B and 1D) of an irrigation dripper 10, according to some embodiments of the present invention. Dripper 10 comprises an external elongated hollow structure 12 having a rigid wall 14 and optionally and preferably, but not necessarily, a flexible wall 16, and an internal elongated structure 18 introduced into external structure 12 to form a pathway 20 for a flow of liquid (e.g., water) between internal structure 18 and walls 14 and 16.

In the schematic illustrations of FIGS. 1A-D, the volume defined by rigid wall 14 has a shape of a cylindrical segment, which is the solid cut from a cylinder by a plane parallel to the cylinder's longitudinal axis. However, this need not necessarily be the case, since, for some applications, it may not be necessary for rigid wall 14 to define a volume having such a shape. For example, rigid wall 14 can define a volume having the shape of a prism (e.g., a triangular prism, a parallelepiped, a square cuboid, a rectangular cuboid etc.).

Internal elongated structure 18 is optionally and preferably non-hollow. For example, structure 18 can be in the form of a rod. The rod can have any shape, such as, but not limited to, a cylinder or a prism (e.g., a triangular prism, a parallelepiped, a square cuboid, a rectangular cuboid etc.). Preferably, the shape of structure 18 is compatible (e.g., the same or similar, except with reduced transverse dimension) as the shape of the volume defined by the rigid wall 14. Representative examples of embodiments in which the volume defined by rigid wall 14 is non-cylindrical, and in which the internal elongated structure 18 is shape-wise compatible with rigid wall 14 are illustrated in FIGS. 1E and 1F, where FIG. 1E illustrates an embodiment in which structure 18 and the volume defined by rigid wall 14 have the shape of a square cuboid, and FIGS. 1E and 1F, where FIG. 1E illustrates an embodiment in which structure 18 and the volume defined by rigid wall 14 have the shape of a square cuboid, and FIG. 1F illustrates an embodiment in which structure 18 and the volume defined by rigid wall 14 have the shape of a rectangular cuboid.

Irrespectively of the shape of rigid wall 14, pathway 20 is optionally and preferably peripheral with respect to internal structure 18, and allows water to flow at a plurality of directions at any point along a length of dripper 10. This is advantageous because it reduces the likelihood for occlusion. Specifically, when an obstacle, such as a solid particle or an air bubble is trapped between internal structure 18 and one of the walls of external hollow structure 12, there are several alternative paths within pathway 20 allowing the liquid to bypass the obstacle so that pathway 20 is not completely blocked by the obstacle, and there is no clogging. Preferably, water pathway 20 forms at least a two-dimensional surface within dripper 10.

Dripper 10 comprises an inlet 22 for providing liquid (e.g., water) to pathway 20, and an outlet 24 on external structure 12 for allowing the liquid to drip out of pathway 20. Outlet 24 is shown in FIGS. 1A-D as circular, but other shapes for outlet 24 (e.g., oval, polygonal) are also contemplated. In the schematic illustrations of FIGS. 1E and 1F, for example, dripper 10 has an oval outlet 24. The diameter of the inlet 22 is preferably from about 50 μm to about 5000 μm. The diameter of outlet 24 is optionally and preferably the same, or approximately the same, as the diameter of pathway 20. A Cartesian coordinate system is shown in FIGS. 1A and 1C. The direction along internal structure 18 is referred to herein as the longitudinal direction y, and the direction perpendicular to the longitudinal direction y and to the direction z defined by outlet 24 is referred to as the transverse direction x.

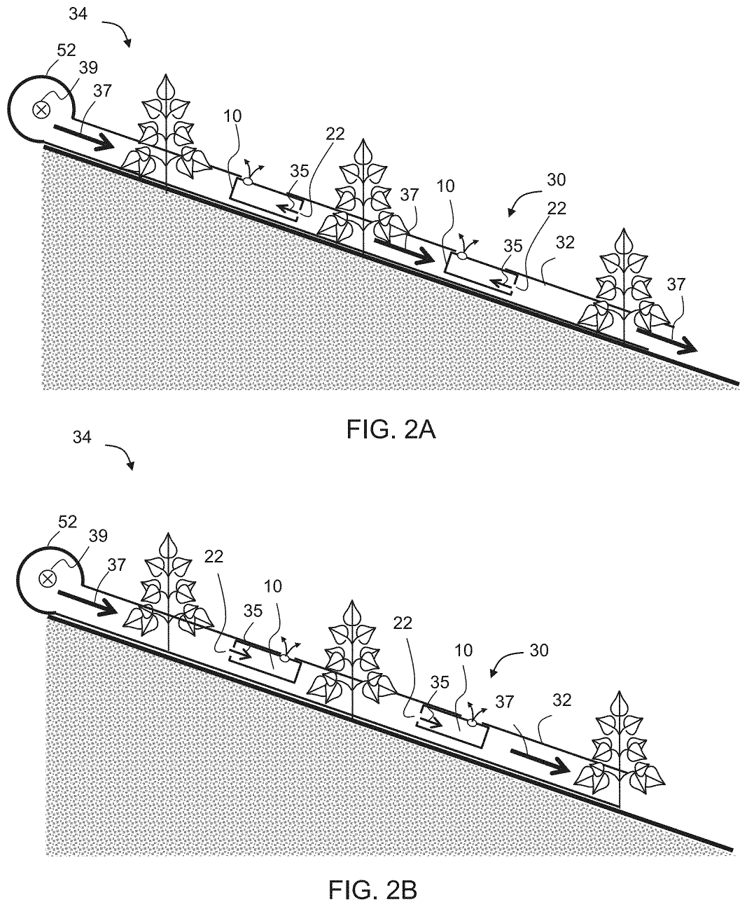

FIGS. 2A and 2B schematically illustrate an irrigation dripping pipe 30, according to some embodiments of the present invention. Irrigation dripping pipe 30 typically comprises an irrigation pipe 32 provided with one or more drippers such as, but not limited to, dripper 10, is deployed in a field 34 and liquid 37 (e.g., water) is introduced to pipe 32. Liquid 37 is typically introduced from a distributing line 52 (aligned in FIGS. 2A and 2B perpendicular to the plane of the drawing) or directly from a liquid source (not shown). The flow 39 of liquid in distributing line 52 is illustrated as circled crosses which represent a direction into the plane of the drawings. FIG. 2A illustrates a preferred embodiment in which the inlet 22 is downstream with respect to the flow 37 outside the dripper, so that the inflow 35 of liquid (e.g., water) through inlet 22 is opposite to the flow 37 in pipe 32 outside the dripper. In experiments performed by the Inventors it was unexpectedly discovered that such a construction of irrigation dripping pipe 30 provide a more efficient dripping with less clogging, and significantly reduces the maintenance effort required to maintain dripping. Yet, irrigation dripping pipes in which the inlets of the drippers is upstream with respect to the flow outside the dripper (namely irrigation dripping pipes in which so that the inflow of through the inlets are generally along the direction of the flow in the pipe outside the dripper) are also contemplated, and are illustrated in FIG. 2B.

A typical distance between two adjacent drippers along pipe 32 is, without limitation, from about 20 to about 100 cm. The liquid 37 flows in pipe 32, generally along the longitudinal direction, enters the dripper(s) 10 through their inlets, and then drips out through their outlets, irrigating the crop in the field. FIGS. 2A-B illustrate a preferred embodiment of the invention in which the irrigation dripping pipe 30 is placed on a ground that is inclined, in a manner that dripping pipe is also inclined at the same slope as the ground or at a different (typically smaller) slope. The advantage of this embodiment is that the liquid pressure in the pipe is generated, at least in part by the gravitation force. The present embodiments also contemplate configurations in which the irrigation dripping pipe 30 is generally horizontal (e.g., within 5% deviation), e.g., placed on a ground that is not inclined.

The inventors of the present invention found that dripper 10 is capable of dripping without clogging at low pressures. Thus, in some exemplary embodiments of the invention irrigation the liquid pressure at the entry of pipe 32 is less than 0.1 bar, more preferably from about 5 mbar to about 90 mbar, more preferably from about 5 mbar to about 80 mbar, more preferably from about 5 mbar to about 70 mbar, more preferably from about 5 mbar to about 60 mbar, more preferably from about 5 mbar to about 50 mbar, more preferably from about 5 mbar to about 40 mbar e.g., 30 mbar. The advantage of these embodiments is that the energy that is needed to provide higher pressures in conventional system is saved.

Irrigation pipe 32 can be made of any suitable material known in the art to operate normally to withstand pressure of at least 1 bars, to withstand accidental pressures as a result of loads generated, for example, by overridden wheels of a vehicle, and/or to withstand weather conditions, such as rain, or high temperatures typically caused from heat generated by the sun. For example, suitable materials may be polyethylene, polypropylene, polyvinylchloride and other thermoplastic materials. Typically, irrigation pipe 32 has a diameter of from about 12 mm and to about 60 mm, and length of from about 5 m to about 800 m.

Optionally, the liquid 37 supplied to pipe 32 is a natural water that contains at least M mg per liter of total suspended solids. In some embodiments of the present invention the water is not filtered prior to entering irrigation pipe 32 so that it still contains M mg per liter of total suspended solids within pipe 32 and within the drippers 10. Typical values of M include, without limitation, at least 70, or more preferably at least 80, or more preferably at least 90, or more preferably at least 100, or more preferably at least 110, or more preferably at least 120, or more preferably at least 130. Alternatively, M can be less than 50.

The rigid wall 14 of dripper 10 is optionally and preferably fabricated from the same material as pipe 32. The advantage of this embodiment is that it facilitates easy assembling and recycling.

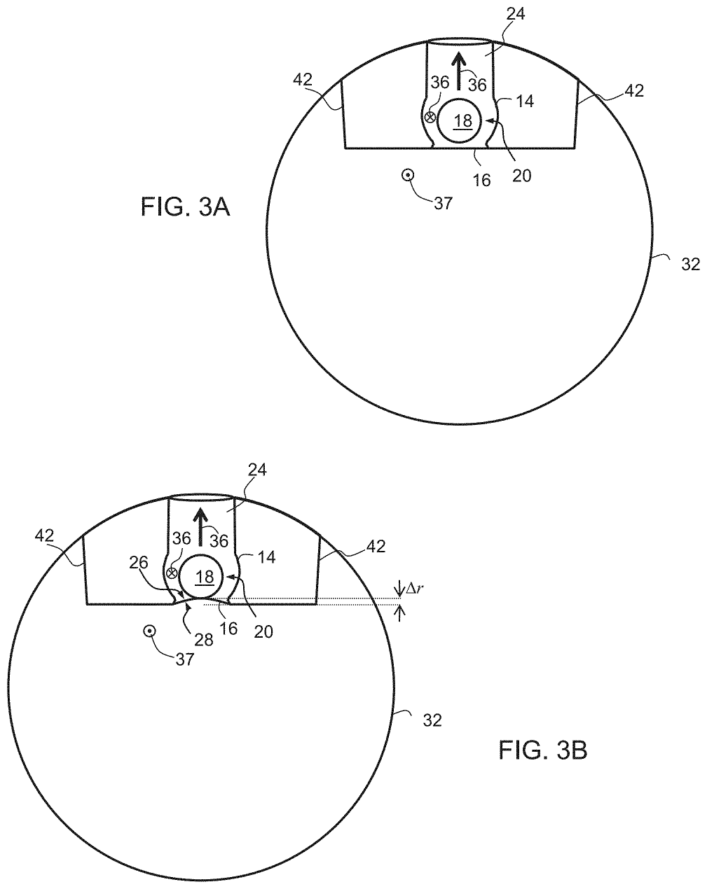

The flexible wall 16 serves as a flow regulating member of dripper 10. This will be explained with reference to FIGS. 3A and 3B, which are cross-sectional schematic illustrations of dripper 10 within pipe 32, in a plane perpendicular to the longitudinal axis of pipe 32 (perpendicular to the flow in the pipe), and passing through the outlet 24 of dripper 10. The flow of liquid in pipe 32 is illustrated as circled dot 37 which represent a direction out of the plane of the drawings, and flow of liquid in pathway 20 of dripper 10 is illustrated as circled crosses which represent a direction into the plane of the drawings. Thus, FIGS. 3A and 3B correspond to the embodiment illustrated in FIG. 2A. The ordinarily skilled person, provided with the details in this disclosure would know how to adjust FIGS. 3A and 3B to the embodiment illustrated in FIG. 2B. The flow 36 of liquid in outlet 24 of dripper 10 is generally perpendicular to the flow in pathway 20 (upwards, in FIGS. 3A and 3B), and is illustrated by an arrow. At locations along pipe 32 at which there is no pressure drop on flexible wall 16, flexible wall 16 can assume a generally flat shape along the transverse direction x, as illustrated in FIG. 3A, or it can be curved outwardly (not shown, see FIG. 1D). FIG. 3B illustrates a location along pipe 32 at which there is a pressure drop on flexible wall 16. In a typical scenario of a pressure drop, the liquid pressure at the outer side 28 of wall 16 is higher than the liquid pressure at the inner side 26 of wall 16, in which case wall 16 is curved inwardly and partially restricts pathway 20, reducing the flow in pathway 20 and through outlet 24.

The curvature of wall 16 is proportional to the pressure drop across wall 16 ensuring that the extent of restriction in pathway 20 is inversely proportional to this pressure drop. Thus, dripper 10 is a flow regulated dripper. In some cases the liquid pressure upstream pipe 32 is higher and gradually decreases downstream pipe 32, this is a typical situation when pipe 32 is not inclined. In other cases, the liquid pressure along pipe 32 is non-monotonic (e.g., reaching a minimum at one or more locations along the pipe). This is a typical situation when pipe 32 is inclined. By providing pipe 32 with a plurality of flow regulated drippers like dripper 10, the pathways 20 of drippers are less restricted at locations in which the liquid pressure in the pipe is lower than at locations in which the liquid pressure in the pipe is higher, ensuring a generally uniform flow rate (e.g., with flow rate variations of less than 30% or less than 20% or less than 10%) at the outlets 24 of the drippers.

According to some embodiments of the invention flexible wall 16 is characterized by a Young modulus of from about 5 MPa to about 150 Mpa.

Flexible wall 16 can be embodied in more than one way. Preferably, flexible wall 16 is made of the same material as the rigid wall 14 of the external structure 12. In some embodiments of the present invention, wall 16 is in the form of a membrane attached to rigid wall 14, as illustrated in FIGS. 1A-D. The membrane can extend along the entire length of dripper 10 (along the longitudinal direction y), or along a portion of its length. The membrane can be made of any flexible material, and is preferably non-permeable to water. In some embodiments of the present invention the membrane is flexible and elastic. Also contemplated are embodiments in which the membrane is flexible but not elastic. Representative example of materials suitable for the membrane include, without limitation, elastomeric material, rubber, polyvinyl chloride, polyurethane, VLDPE, and ULDPE. When the membrane comprises a polyurethane the polyurethane is optionally and preferably combined with other materials to provide a substance characterized by a Young modulus of from about 5 MPa to about 150 Mpa. VLDPE, and ULDPE are commercially available, for example, from Dow Chemical, and Nova Chemical.

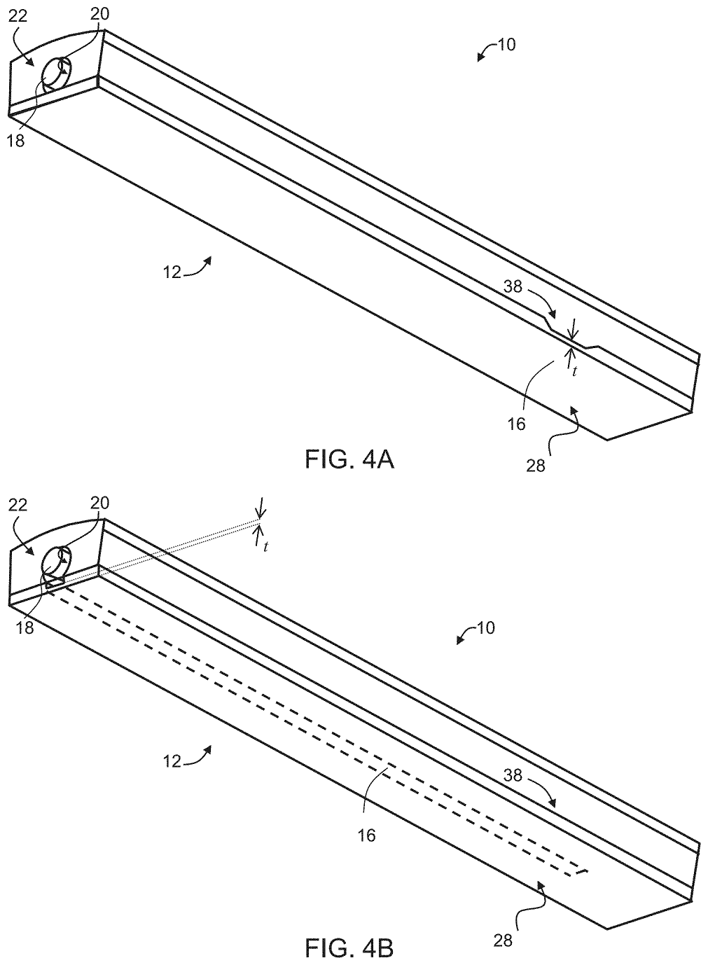

Flexible wall 16 can, in some embodiments of the present invention, be made of the same material as rigid wall 14 except at a smaller thickness. A representative example of these embodiments is illustrated in FIGS. 4A and 4B. The smaller thickness t can be realized at one or more discrete regions 38 along the length of pathway 20, as illustrated in FIG. 4A, or to extend along the entire length of pathway 20, as illustrated in FIG. 4B. In some embodiments of the present invention, the smaller thickness t is realized only at the vicinity of the lumen of hollow structure 12.

Additional representative examples of materials suitable for use as flexible wall 16, in any of the embodiments described herein, are provided in the Examples section that follows.

A typical thickness for flexible wall 16, in any of the embodiments described herein, is from about 20 microns to about 200 microns, more preferably from about 50 microns to about 150 microns.

The size and the material of flexible wall 16 are optionally and preferably both selected such that flexible wall 16 exhibits a sufficiently high deformation in response to a sufficiently low pressure difference ΔP between the inner side 26 and outer side 28 of wall 16. The deformation of wall 16 can be parameterized by the maximal displacement Δr of wall 16 inwardly (see FIG. 3B). Typical values for ΔP are at most 400 cmH₂O or at most 200 cmH₂O or at most 100 cmH₂O or at most 50 cmH₂O or at most 25 cmH₂O or at most 10 cmH₂O or at most 5 cmH₂O or at most 2.5 cmH₂O, and typical values of Δr are at least 10 μm or at least 20 μm or at least 40 μm or at least 80 μm or at least 100 μm. Preferably, flexible wall 16 is elastic under a pressure difference of ΔP.

Generally, flexible wall 16 can have any shape in the absence of a pressure difference ΔP between its inner 26 and outer 28 sides. In the schematic illustration shown in FIGS. 1A and 1B, flexible wall 16 is substantially planar (e.g., with deviation of less than 10% from planarity) in the absence of a pressure drop thereacross. In the schematic illustration shown in FIGS. 1A and 1B, flexible wall 16 is substantially planar (e.g., with deviation of less than 10% from planarity) in the absence of a pressure drop thereacross. This can be achieved, for example, by providing the outer surface 40 of rigid wall 14 with two generally planar structures 42 intersecting with flexible wall 16. Structures 42 are typically generally parallel to each other (e.g., with deviation of less than 10° from parallelism).

In the schematic illustration shown in FIGS. 1C and 1D, flexible wall 16 is curved in the absence of a pressure drop thereacross. This can be achieved, for example, by providing an outer surface 40 of rigid wall 14 which is tapered towards flexible wall 16. For example, outer surface 40 can have two generally planar structures 42, at an angle to each other, intersecting with flexible wall 16.

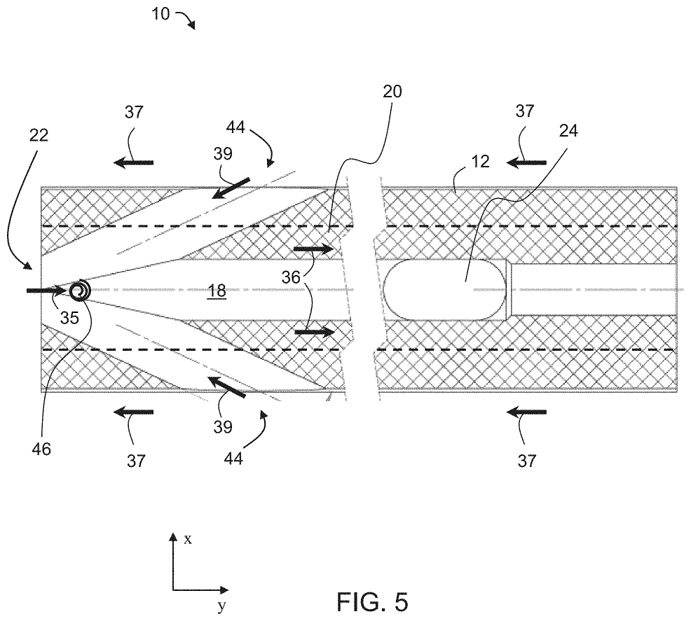

Reference is now made to FIG. 5, which is a schematic illustration of dripper 10 in embodiments of the invention in which the flow regulation is facilitated, at least in part, by inducing flow perturbation in pathway 20. In these embodiments, the external elongated hollow structure 12 is formed with through holes 44. Holes 44 are preferably shaped to perturb the flow in pathway 20 in response to a pressure drop across holes. For example, through holes 44 can be at an angle to the longitudinal direction oriented such that they are closer to inlet 22 within pathway 20 than outside dripper 10. With such a configuration, turbulences 46 occur within pathway 20 near holes 44, wherein the level of turbulence increases with the pressure drop across the holes 44. The turbulences 46 perturb the flow in pathway 20, so that for higher pressure drop across holes 44 (typically upstream the irrigation pipe), there is higher perturbation to the flow, and for lower pressure drop across holes 44 (typically downstream the irrigation pipe), there is lower perturbation to the flow. Thus, through holes 44 serve as a flow regulating members of dripper 10.

Through-holes 44 can be used either in addition to the flexible wall 16 of device 10 (not shown in FIG. 5, see e.g., FIGS. 1A-D), or as alternative flow regulating members, in which case dripper 10 need not have a flexible wall.

The rigid wall 14 and its outer surface 40 optionally and preferably form a monolithic structure, which can be manufactured by any technique known in the art, including, without limitation, injection molding and extrusion. Extrusion is preferred from the standpoint of surface finish, and the ability to handle mass production more easily than with molding. Extrusion is a process in which a block of the material from which the monolithic structure is to be made is forced through an extrusion die with a ram tool that applies to the block an extrusion force, which plasticizes the material. The plasticized material is then extruded through the orifice of the extrusion die to form the monolithic structure. The cross-sectional pattern of the monolithic structure is formed by the shape of the extrusion die. Rigid wall 14 and its outer surface 40 can be fabricated by direct or indirect extrusion. In direct extrusion, the extrusion die and a solid ram are positioned on opposite ends of the material's block. In indirect extrusion, the extrusion die is attached to a hollow ram on the same side of the block. Optionally and preferably a mandrel is attached to the hollow ram to make a volume for receiving the internal structure 18.

In embodiments in which the flexible wall 16 is embodied as a region of smaller thickness compared to rigid wall 14, the rigid wall 14, the outer surface 40 and the flexible wall 16 optionally and preferably form a monolithic structure. Such monolithic structure can also be made by extrusion, for example, by constructing the extrusion die in a manner that material extruded through the die forms wall portions that are thinner comparted to other portions. Alternatively, the extrusion process can provide an initial body for the external elongated hollow structure 12 of dripper 10, whereby flexible wall 16 is fabricated in a post-extrusion step by thinning one or more regions the hollow structure 12.

In embodiments in which the flexible wall 16 is embodied as a membrane, the membrane can be manufactured by a process other than extrusion, or, alternatively, it can also be fabricated by extrusion. When the membrane is fabricated by extrusion it is optionally and preferably coextruded with the monolithic structure of the rigid wall 14 and outer surface 40.

As used herein, “co-extrusion,” refers to the process of extruding one or more materials through a single die with two or more orifices arranged so that the extruded material(s) exits through the two or more orifices together, and then merge and weld to each other before cooling or chilling.

The advantage of co-extruding the membrane and the monolithic structure is that it saves the process step of attaching the membrane to the rigid wall.

As used herein the terms “about” and “approximately” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non limiting fashion. The examples below provide suitable materials for use as the flexible wall of the dripper of the present embodiments. Other materials are also contemplated.

Low-density polyethylene (LDPE) is marketed by ExxonMobil™, and has a density range from about 0.913 to 0.934 g/cm³.

Ethylene and acrylic acid (EAA) copolymer (e.g., Escor™, by ExxonMobil™).

Ethylene methyl acrylate (EMA) copolymers (e.g., the Optema™ EMA copolymer, by ExxonMobil™), which can be processed by extrusion coating lamination, blown/cast monolayer and coextruded films, injection molding, sheet or profile extrusion, blow molding and foam extrusion.

Ethylene n-butyl acrylate copolymers, e.g., (EnBA by ExxonMobil™), which are known to adhere to a variety of polar substrates including paper, polyesters, ionomers, PVdC and unplasticized PVC.

Ethylene vinyl acetate (EVA) copolymers (e.g., Escorene™ by ExxonMobil™).

Exact™ plastomers by ExxonMobil™, which are ethylene alpha olefin copolymers.

Lucalen A2700M by LyondellBasell Industries is a low density polyethylene, containing butyl acrylate co-monomer.

Lucalen A2700H by LyondellBasell Industries is a low density polyethylene, containing butyl acrylate co-monomer.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An irrigation dripper comprising:
an external elongated hollow structure having a rigid wall and a flexible wall;
an internal elongated structure introduced into said external structure to form a pathway for flow between said internal structure and said walls;
an inlet for providing water to said pathway; and
an outlet on said external structure for allowing water to drip out of said pathway.

2. The irrigation dripper according to claim 1, wherein said flexible wall is generally planar in the absence of pressure difference between an inner side and an outer side thereof.

3. The irrigation dripper according to claim 1, wherein said flexible wall is curved in the absence of pressure difference between an inner side and an outer side thereof.

4. The irrigation dripper according to claim 1, wherein a volume defined by said rigid wall has a shape of a cylindrical segment.

5. The irrigation dripper according to claim 1, wherein a volume defined by said rigid wall has a shape of a prism.

6. The irrigation dripper according to claim 1, wherein an outer surface of said rigid wall has two generally planar structures intersecting with said flexible wall.

7-9. (canceled)

10. The irrigation dripper according to claim 1, wherein an outer surface of said rigid wall is tapered towards said flexible wall.

11-13. (canceled)

14. The irrigation dripper according to claim 1, wherein said flexible wall is a membrane attached to said rigid wall.

15. (canceled)

16. The irrigation dripper according to claim 1, wherein said flexible wall is made of the same material as said rigid wall except at a smaller thickness.

17. (canceled)

18. The irrigation dripper according to claim 1,
wherein a size and a material of said flexible wall are both selected such that a pressure difference of ΔP between an inner side and an outer side thereof, generates an inward displacement of said flexible wall by Δr, wherein said ΔP is at most 400 cmH₂O and said Δr is at least 5 μm and at most 200 μm.

19. (canceled)

20. The irrigation dripper according to claim 1, wherein said internal elongated structure is non-hollow.

21. (canceled)

22. The irrigation dripper according to claim 1, wherein said external elongated hollow structure is formed with through holes at said rigid wall, said holes being shaped to perturb said flow in response to a pressure drop across said holes.

23. (canceled)

24. An irrigation dripper comprising:
an external elongated hollow structure formed with through holes at a wall thereof;
an internal elongated structure introduced into said external structure to form a pathway for flow between said structures, wherein said holes are shaped to perturb said flow in response to a pressure drop across said holes;
an inlet for providing water to said pathway; and
an outlet on said external structure for allowing water to drip out of said pathway.

25-26. (canceled)

27. The irrigation dripper according to claim 24, a wherein a cross section of an outer surface of said external structure, perpendicular to a longitudinal axis, is generally rectangular.

28. The irrigation dripper according to claim 24, wherein an outer surface of said external structure is tapered.

29. (canceled)

30. The irrigation dripper according to claim 24, wherein
said internal elongated structure is non-hollow.

31. (canceled)

32. The irrigation dripper according to claim 1, wherein said inlet is peripheral with respect to said internal elongated structure.

33. (canceled)

34. An irrigation dripping pipe, comprising an irrigation pipe provided with a plurality of drippers, wherein at least one of said drippers is the irrigation dripper according to claim 1.

35. (canceled)

36. The irrigation dripping pipe according to claim 34, wherein said irrigation pipe has a first end connectable to a water source or a water distribution line, and second end distal to said first end, and wherein for at least one of said drippers, said inlet is facing said second end such that an inflow of water into said at least one dripper is opposite to a flow of water in said irrigation pipe.

37. (canceled)

38. An irrigation dripping pipe, comprising:
an irrigation pipe having first end connectable to a water source or a water distribution line, and second end distal to said first end; and
a plurality of drippers distributed along said irrigation pipe, wherein each dripper has an inlet for receiving water flowing in said irrigation pipe and an outlet for allowing water flowing in said dripper to drip out of said dripper, and wherein for at least one of said dripper said inlet is facing said second end such that an inflow of water into said at least one dripper is opposite to a flow of water in said irrigation pipe.

39. (canceled)
